(19) United States
(12) Patent Application Publication
(10) Pub. No.: US 2011/0020043 A1
(43) Pub. Date: Jan. 27, 2011

(54) DEVICE AND METHOD FOR DRAWING A WEB OF PRINTABLE CARRIER MATERIAL

(75) Inventor: Christian Kürmeier, Erding (DE)

Correspondence Address: SCHIFF HARDIN, LLP;PATENT DEPARTMENT, 233 S. Wacker Drive-Suite 6600, CHICAGO, IL, 60606-6473, US

(73) Assignee: KONICA MINOLTA HOLDINGS, INC., Chiyoda-ku, Tokyo (JP)

(21) Appl. No.: 12/671,999

(22) PCT Filed: Aug. 6, 2008
(86) PCT No.: PCT/EP08/60336

§ 371 Date: Feb. 3, 2010

(30) Foreign Application Priority Data
Aug. 9, 2007 (DE) 10 20070037 653.9

(51) Int. Cl. B41J 11/42

(52) U.S. Cl. 400/611

(57) ABSTRACT

In a device or method for drawing a web made of a printable substrate material in a printer or copier, the web is directed in a transport gap between a drive roller and a contact pressure roller. The drive roller is driven by a motor via an electrically controllable coupling. The coupling is controlled so that the web is charged with a predetermined draw force by the drive roller. A rotation of the drive roller is detected wherein, given a set operating state with a standstill of the web, the controllable coupling is controlled depending on the detected rotation so that a draw force of the drive roller is reduced until the drive roller comes to a standstill.

### BACKGROUND

The preferred embodiment concerns a device to draw off a web of printable substrate material.

The preferred embodiment concerns a device to draw off a web of substrate material in a printer or copier, in which the web is directed between a drive roller and a contact pressure roller. The drive roller is driven by means of a motor. The preferred embodiment also concerns a method to draw off a web.

The present preferred embodiment can in particular be used in electrographic printers and copiers in which a tractorless transport of the continuous web made of substrate material occurs. In such a printer or copier, the substrate material is initially provided with a toner image and the web is conveyed further to a fixing station. The web may not sag in the region between the transfer printing and the fixing; rather, it must be driven taut, in a tensioned state, so that the as of yet unfixed toner image on the web does not come into contact with other apparatus parts and is blurred. To generate the force, known loop pullers can be used that generate the web tension via the weight of a dancing roller, wherein the web is held in fixing rollers in the downstream fixing station. In an operating state in which the printer or copier does not print and the web is not conveyed forwards, a holding of the web by the hot fixing rollers cannot occur for temperature reasons, and the required web tension can no longer be maintained.

An additional possibility to maintain a specific web tension is to continuously draw off the web with the aid of motor-driven contact pressure rollers. The actuation occurs such that the contact pressure rollers rub on the surface of the web with slippage, whereby print quality losses can occur.

### SUMMARY

It is an object to specify a simple solution for a device and a method to draw off a web that provides the required web tension without slippage.

In a device or method for drawing a web made of a printable substrate material in a printer or copier, the web is directed in a transport gap between a drive roller and a contact pressure roller. The drive roller is driven by a motor via an electrically controllable coupling. The coupling is controlled so that the web is charged with a predetermined draw force by the drive roller. A rotation of the drive roller is detected wherein, given a set operating state with a standstill of the web, the controllable coupling is controlled depending on the detected rotation so that a draw force of the drive roller is reduced until the drive roller comes to a standstill.

### BRIEF DESCRIPTION OF THE DRAWINGS

FIG. 1 shows as an exemplary embodiment a principle representation in which a motor drives a drive roller via an electrically operable coupling.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and method, and such further applications of the principles of the invention as illustrated as would normally occur to one skilled in the art to which the invention relates are included.

According to the preferred embodiment, the web is directed between a drive roller and a contact pressure roller. The drive roller is driven by a motor via an electrically controllable coupling. The coupling is activated so that the web is charged with a predetermined tensile force by the drive roller.

The web tension can be set to different values by connecting in series an electrically controllable coupling with a continuous degree of coupling variable via the supplied current. Furthermore, the web tension can be set in the print operation and even during a standstill of the web so that no slippage or only a minimal slippage occurs. The motor itself can be operated so that it can convey the web with a speed that is greater than the speed of the web in a printing process. The reduction to the process speed during printing, or to other values (for example given a standstill of the web) occurs via the electrically controllable coupling, wherein the motor continues to turn.

For a better understanding of the present preferred embodiment, in the following reference is made to the preferred exemplary embodiment shown in the drawing which is described using specific terminology.

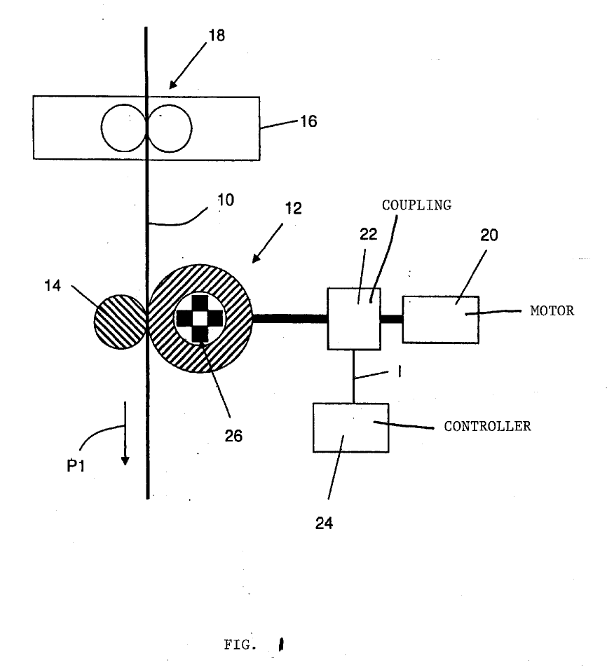

In FIG. 1, a continuous web 10 of a printable substrate material is directed between a drive roller 12 and a contact pressure roller 14. The surface of the drive roller 12 is made of metal. The contact pressure roller 14 comprises multiple cylinders spaced apart from one another, which cylinders are made of heat-resistant plastic, advantageously from Teflon. The coverings thus are comprised of hard material so that the web 10 is directed between the rollers 12, 14 nearly without wrap angle.

In a normal printing operation, the drive roller 12 and the contact pressure roller 14 are arranged in immediate proximity in the transport direction P1, just after a fixing station 16 that contains a fixing roller pair 18 that fixes toner images on the web with application of pressure and temperature. In the case of a standstill of the web 10, the fixing roller pair 18 can be driven apart from one another so that the web 10 is not exposed to the high temperature and pressure.

The drive roller 12 is driven by a motor 20 (advantageously a step motor) via an electrically controllable coupling 22. A hysteresis coupling or a magnetic particle clutch can advantageously be used as a coupling, wherein the coupling efficiency can be continuously adjusted dependent on the supplied current I of a controller 24. The magnetic particle clutch is a frictionally engaged coupling. A metal powder or metal gel is located in a gap between a drive pressure plate and an output pressure plate. The electromagnet housed in one pressure plate magnetizes the metal particles and stiffens them. A positive connection is thereby achieved. A firm connection or slip is generated by changing the supplied current. Without current, no forces are transferred because the metal particles rest on the drive pressure plate due to the centrifugal force. In the hysteresis coupling, a coupling half is populated with a hysteresis coating. This hysteresis material acts similar to permanent magnets but its polarity can be reversed with little energy cost. If the nominal moment of the coupling is exceeded, the coupling begins to slip through. The hysteresis material thereby accepts energy from the drive system via the continuous polarity reversal due to the permanent magnets rotating past and transduces this into waste heat that is discharged into the surroundings.

A rotation speed sensor 26 detects the rotation of the drive roller 12. The controller 24 adjusts the current I depending on the detected rotation.

With the aid of the device shown in FIG. 1, different torques at the drive roller 12 or draw forces which act on the web 10 can be set for different operating states of the printer or copier. The different operating states are described in the following.

In a first operating state which pertains to the preparation phase of the printer or copier with inserted web 10, the optimal torque Mo to be transferred from the coupling 22 is determined. This value Mo is found by the following regulation algorithm. First the motor 20 is operated. The electrical coupling 22 is supplied with a current I that charges the web 10 with a maximum allowable discharge force via the drive roller 12. The discharge roller 12 accordingly rotates. The rotation of the discharge roller 12 is detected with the aid of the rotation speed sensor 26. Assuming the maximum allowed discharge force, the current I at the coupling 22 is reduced until the drive roller 12 stands still. The associated value Mo is set at the speed “zero”, i.e. the standstill of the web 10. At this value Mo there is no slippage between the drive roller 12 and the surface of the web 10, such that a possible printed print image is not blurred after the regulatory process subsides. A blurring of the print image is minimized in this way, despite maximum discharge force. This procedure can also be implemented at every stop of the printer or copier.

A second operating state concerns the acceleration of the web 10 to process speed at which the web is continuously printed. For this a torque Ms is set which is greater than Mo, such that the intertias of masses of the participating components are overcome given an acceleration of the web 10. In this operating state the drive roller 12 is accelerated to the process speed at which a continuous printing on the web 10 occurs. The motor 20 is operated with a maximum speed Vmax which is composed of Vb and Vd, i.e. Vmax=Vb+Vd. Vb is herein the speed of the web 10 at process speed. Vd is an excess speed that corresponds to approximately 2 to 3% of the speed Vb.

A third operating state pertains to the normal printing process. The torque transferred from the coupling 22 to the drive roller 12 reduces from Ms to Md, wherein Md is the torque in normal printing operation. The drive roller 12 then has the transport speed of the web 10 which corresponds to the speed upon printing the web 10. The motor 20 is operated with maximum speed Vmax.

A fourth operating state concerns the halting of the web 10 and the retraction of the web 10 counter to the transport direction P1. This retraction is required since a subsequent printing of the web 10 can only occur if the web 10 has been accelerated again to process speed Vb. For this a certain run-up is required, which makes the retraction of the web 10 by a predetermined length necessary. First the drive roller 12 must be braked until it has a speed of zero. The torque that is transferred for this corresponds to the aforementioned value Md. The motor 20 is run down to the value Vs corresponding to a ramp-shaped characteristic stop line, which value Vs corresponds to the speed during standby operation in which the printer is held in readiness in order to begin with the printing operation after receiving the print data. The retraction of the web 10 counter to the transport direction P1 occurs with a torque Mr, wherein Mr is a great deal higher than Md. The drive roller 12 rotates corresponding to a retraction speed Vr. The motor 20 rotates with the standby speed Vs.

A fifth operating state concerns the standstill of the web 10. The torque Mo is hereby set by the coupling 22. The speed of the drive roller 12 is regulated to zero and remains at this value for the duration of this operating state. The motor 20 assumes the speed Vs.

A sixth operating state concerns a long standstill phase of the web 10. The coupling 22 transfers the torque Mo. The drive roller 12 has the speed zero. The motor 20 is also regulated to the speed zero. In the case of a step motor, a holding current is applied to it.

A seventh operating state concerns a slow forward movement in the transport direction P1 of the web 10, for example in order to drive the end segment of the web 10 out of the printer. For this the maximum allowable torque Mm is initially set by the coupling 22 and is subsequently adjusted to Mo. The speed of the drive roller 12 is set to the predetermined forward speed. The motor 20 is operated with standby speed Vs.

An eighth operating state concerns the slow backward movement of the web 10. For this the torque Mr is set by the coupling 22. The contact pressure roller 12 rotates with the predetermined backward speed. The motor 20 is set to standby speed Vs.

A plurality of operating states that are required for a printer or copier can be generated with the aid of the described device and the different methods. Since the device operates with high precision, a maximum possible torque Mm can be set, whereby a high web tension for drawing off is achieved. In each operating state of the printer or copier, a torque that is ideal for this state can be set. A constant and, in every operating state, nearly identical web tension can thereby be generated.

Via the use of the controllable coupling 22, paper-specific web tensions can be freely set by an operator, or values of the web tension that are recorded in tables can be accessed.

As a result of dividing up the contact pressure roller 14 to a plurality of cylinders, a uniform web tension is automatically set over the width of the web 10, even given a web 10 of differing width. Since the device operates without slippage or with negligible slippage, a damage to the print image and the web 10 is prevented. A toner abrasion is avoided due to the anti-slip regulation. The device ensures a reliable draw-off of the web 10 from the fixing station 16, such that an adhesion of the web 10 to the fixing roller pair 18 is prevented.

Although preferred a exemplary embodiment has been shown and described in detail in the drawings and in the preceding specification, it should be viewed as merely exemplary and not as limiting the invention. It is noted that only the preferred exemplary embodiment is presented and described, and all variations and modifications that presently and in the future lie within the protective scope of the invention should be protected.

I claim as my invention:

1-5. (canceled)

6. A device for drawing a web made of a printable substrate material in a printer or copier, comprising:
a drive roller and a contact pressure roller, and the web being located between the drive roller and the pressure roller;
a motor driving the drive roller via an electrically controllable coupling;
the coupling being controlled so that the web is charged with a predetermined draw force by the drive roller; and
a rotation speed sensor which detects a rotation of the drive roller and, given a set operating state with a standstill of the web, the controllable coupling by the device roller is controlled depending on the detected rotation of the drive roller so that a draw force is reduced until the drive roller comes to a standstill.

7. A device according to claim 6, in which a hysteresis coupling or a magnetic particle coupling whose coupling efficiency is continuously adjustable is provided as said electrically controllable coupling.

8. A device according to claim 6 in which at least one of the drive roller and the contact pressure roller has a covering made of material containing Teflon.

9. A device according to claim 6 in which the drive roller is arranged after a fixing station as viewed in a transport direction of the web.

10. A method for drawing a web made of a printable substrate material in a printer or copier and wherein the web is directed in a transport gap between a drive roller and a contact pressure roller, comprising the steps of:
driving the drive roller by a motor via an electrically controllable coupling;
controlling the coupling so that the web is charged with a predetermined draw force by the drive roller; and
detecting a rotation of the drive roller wherein, given a set operating state with a standstill of the web, the controllable coupling is controlled depending on the detected rotation so that a draw force of the drive roller is reduced until the drive roller comes to a standstill.
